(19) United States
(12) Patent Application Publication
(10) Pub. No.: US 2025/0361762 A1
(43) Pub. Date: Nov. 27, 2025

(54) DISEMBARKING SUPPORT DEVICE AND NON-TRANSITORY STORAGE MEDIUM

(71) Applicants: TOYOTA JIDOSHA KABUSHIKI KAISHA, Aichi-ken (JP); DENSO CORPORATION, Aichi-pref (JP)

(72) Inventors: Hiroaki IIDA, Hashima-shi (JP); Masaho ISHIDA, Toyota-shi (JP); Issei MATSUNAGA, Nagoya-shi (JP)

(21) Appl. No.: 19/205,949

(22) Filed: May 12, 2025

(30) Foreign Application Priority Data
May 23, 2024 (JP) 2024-084209

(51) Int. Cl. E05F 15/73; B60Q 1/50; G06V 20/59

(52) U.S. Cl. CPC E05F 15/73; B60Q 1/525; E05Y 2400/445; E05Y 2900/531; G06V 20/593

(57) ABSTRACT

There is provided a processor for executing disembarking support control for protecting a passenger by issuing a warning in case of a moving body approaching a vehicle is present and a door is in an open state in case of the passenger is disembarking from the vehicle, and the processor executes the following processing. Judging whether the passenger is present in the vehicle in case of ending the disembarking support control, executing output control for outputting notification contents for notifying ending of the disembarking support control in case of it is judged that the passenger is present, and not executing the output control in case of the passenger is not present.

### FIELD

The present invention relates to a disembarking support device and non-transitory storage medium for protecting a passenger in case of the passenger is disembarking from a vehicle.

### BACKGROUND

Disembarking support devices for outputting a predetermined notification content from a notification unit in case of a moving body approaching a vehicle is present in case of a passenger disembarks from the vehicle are known. Patent Literature 1 (JP Patent Publication No. 2023-096767) describes a disembarking support device comprising an exterior sensor for detecting the state outside the vehicle, an interior sensor for detecting the state inside the vehicle, a door sensor for detecting whether the door is open or closed, and a control unit for outputting the notification content in case of a moving body is present based on the detection value of each sensor, and ending the output of the notification content in case of the moving body is no longer present.

According to this disembarking support device, in case of the number of times the notification content has been issued since the door was last opened is equal to or exceeds a reference number, the output of the notification content is limited, thereby reducing the annoyance of the alarm for the passenger.

### SUMMARY

### Technical Problem

According to the technology described in Patent Literature 1, a method for outputting a notification informing the driver of the end of disembarking support in response to the presence of a passenger in the vehicle in case of disembarking support is to be ended has not yet been proposed.

An object of the present invention is to provide a disembarking support device and a non-transitory storage medium which can adjust the output of notification content in case of disembarking support is ended based on the presence or absence of a passenger in the vehicle.

### Solution to Problem

An aspect of the present invention provides a disembarking support device comprising a processor for executing disembarking support control for protecting a passenger by issuing a warning in case of a moving body approaching a vehicle is present and a door is in an open state in case of the passenger is disembarking from the vehicle, the processor executing the following processing of judging whether or not the passenger is present in the vehicle in case of ending the disembarking support control, executing output control for outputting notification contents for notifying ending of the disembarking support control in case of it is judged that the passenger is present, and not executing the output control in case of it is judged that the passenger is not present.

### Advantageous Effects of Invention

According to the present invention, the output of the notification content in case of disembarking support is ended can be adjusted based on the presence or absence of the passenger in the vehicle, thereby reducing the annoyance of the notification given to the passenger.

### BRIEF DESCRIPTION OF DRAWINGS

FIG. 1 is a block diagram showing the configuration of a disembarking support device according to an embodiment.

FIG. 2 is a plan view showing a state in which a moving body approaching a vehicle 1 is present.

FIG. 3 is a flowchart showing the flow of processing of a disembarking support method executed by a disembarking support device.

### DESCRIPTION OF EMBODIMENTS

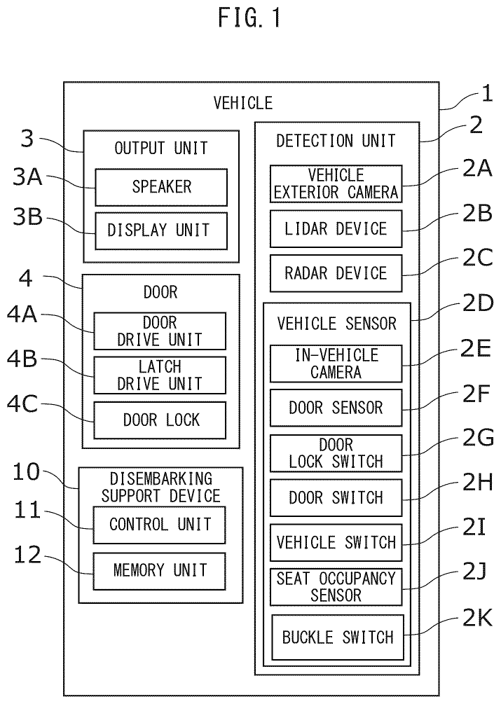

As shown in FIG. 1, the vehicle 1 comprises a disembarking support device 10 for executing disembarking support control to protect the passenger by restricting the opening and closing operations of a door 4 in case of the passenger is disembarking. The disembarking support device 10 controls the door 4 provided in the vehicle 1 based on a detection value of a detection unit 2 for detecting the environment around the vehicle 1. The disembarking support device 10 is configured to restrict the opening and closing operations of the door 4 to protect the passenger in case of a moving body approaching the vehicle 1 is present, for example, and to output a predetermined notification from an output unit 3 to alert the passenger.

The vehicle 1 may be a manually driven vehicle or an automatically driven vehicle. The vehicle 1 may be an internal combustion engine vehicle or an electric vehicle. The vehicle 1 may be a hybrid vehicle having an internal combustion engine and an electric motor.

The door 4 is provided so as to be freely opened and closed so as to allow a passenger to board and disembark the vehicle 1. At least one door 4 is provided in the vehicle 1. When the door 4 is locked by a door lock 4C, the door 4 is in a locked state. When the door 4 is unlocked by the door lock 4C, the door 4 is in an unlocked state. The door lock 4C is switched between a locked state and an unlocked state based on an operation by the passenger.

When the door 4 starts an opening operation in an unlocked state, the door latch is released. The door latch is maintained in a latched state by, for example, a latch drive unit 4B. The latch drive unit 4B is an actuator that operates based on a passenger operation. The door latch may be configured to be automatically released (unlatched state) based on a passenger operation. The door latch may be configured to be automatically fastened (latched state) based on a passenger operation. The door latch may be configured to automatically go from a half-latched state to a latched state based on a passenger operation.

The door 4 may be configured so that the opening and closing operations thereof are automatically controlled. The door 4 is configured as, for example, a power slide door (PSD) which slides in the horizontal direction of the vehicle to automatically open and close. The power slide door is driven by a door drive unit 4A, and the opening and closing operations thereof are controlled by the disembarking support device 10. The power slide door automatically slides in the opening direction, for example, after the door latch is released.

The power slide door stops at the stop position of the opening operation and is maintained in the open state. For example, the power slide door automatically closes from the open state based on an operation of the passenger. When the power slide door stops at the stop position of the closing operation, the door latch automatically locks and the closing operation is completed. The door 4 may be configured to automate or semi-automate normal opening and closing operations as well as the power slide door.

The detection unit 2 is linked to the operation of the door 4 and outputs detection values necessary for disembarking support control to the disembarking support device 10. The detection unit 2 is configured to detect, for example, detection values related to the outside of the vehicle and detection values related to passengers embarking and disembarking. The detection unit 2 is provided with, for example, a vehicle exterior camera 2A which captures the environment around the vehicle 1. The vehicle exterior camera 2A is installed at a position and angle that allow it to capture a moving body approaching the door 4 within the capture range.

The vehicle exterior camera 2A may be used in a drive recorder, or may be used for other driving support control, such as automatic braking, different from disembarking support control. One or more vehicle exterior cameras 2A may be provided in accordance with the number of doors 4. The vehicle exterior camera 2A outputs vehicle exterior image data to the disembarking support device 10.

The detection unit 2 comprises a lidar device 2B and a radar device 2C which detect objects around the vehicle 1. The environment around the vehicle 1 may be detected using not only the vehicle exterior camera 2A but also the lidar device 2B and the radar device 2C. The lidar device 2B scans a scanning range with laser light and receives reflected light to obtain three-dimensional data of the environment around the vehicle 1. The lidar device 2B outputs detection values to the disembarking support device 10. The radar device 2C detects objects present around the vehicle 1 by emitting radar waves and receiving reflected waves. The radar device 2C outputs detection values to the disembarking support device 10.

The detection unit 2 comprises a vehicle sensor 2D for detecting detection values related to embarking and disembarking of passengers. The vehicle sensor 2D comprises, for example, an in-vehicle camera 2E for capturing the interior of the vehicle. The in-vehicle camera 2E is installed in a position in which it can capture each seat provided in the vehicle 1 within a capture range in the vehicle. The in-vehicle camera 2E captures a seat occupancy state of the passenger in each seat. The in-vehicle camera 2E outputs in-vehicle image data to the disembarking support device 10.

The vehicle sensor 2D comprises a door sensor 2F for detecting the open/closed state of the door 4. The door sensor 2F detects, for example, a state in which the latch of the door 4 is released. The door sensor 2F may detect the degree of opening of the door 4. The door sensor 2F monitors, for example, the driving state of the latch drive unit 4B and detects the open state and the closed state of the latch drive unit 4B. The door sensor 2F monitors, for example, the driving state of the door drive unit 4A and detects the degree of opening of the door 4. The degree of opening of the door 4 is, for example, 0% in the closed state and 100% in the fully open state. The door sensor 2F outputs detection values to the disembarking support device 10.

The vehicle sensor 2D comprises a door lock switch 2G for selecting between a locked state and an unlocked state of the door 4. The door lock switch 2G is, for example, a switch which accepts an operation for operating a door lock 4C for driving the lock of the door 4. The door lock switch 2G accepts a lock operation for putting the door lock 4C into a locked state. The door lock switch 2G accepts an unlock operation for putting the door lock 4C into an unlocked state. The door lock switch 2G outputs an operation state including the lock operation and the unlock operation to the door 4 and the disembarking support device 10.

The vehicle sensor 2D comprises a door switch 2H for performing the opening and closing operations of the door 4. The door switch 2H is a switch which accepts, for example, an operation to start an opening operation of the door 4, an operation to start a closing operation of the door 4, and an operation to stop the operation in case of opening or closing the door 4. The door switch 2H comprises an interior switch provided on the interior side of the vehicle and an exterior switch provided on the exterior side of the vehicle. The exterior switch is, for example, a door knob.

The door switch 2H is linked to, for example, the door drive unit 4A and the latch drive unit 4B. When the door 4 is in a closed state, the passenger releases the door lock and operates the door switch 2H to drive the latch drive unit 4B and the door drive unit 4A and start the opening operation of the door 4. The door switch 2H is configured to accept, for example, an opening operation, a closing operation, and a stopping operation. When the opening operation is selected, the door switch 2H opens the door 4.

The door lock switch 2G and the door switch 2H may be configured to operate based on a predetermined gesture by the passenger performed for the in-vehicle camera 2E or a motion sensor (not illustrated) provided in the vehicle 1. The door lock switch 2G and the door switch 2H may be configured to operate based on voice recognition of the passenger. The door lock switch 2G and the door switch 2H may be configured to operate based on the operation of a smart key that can be remotely operated.

The smart key may be realized by an application program installed in an information processing terminal device such as a smartphone carried by the passenger. The door lock switch 2G and the door switch 2H may be configured to be operated by a passenger who has the smart key touching a predetermined position on the door 4.

When the door 4 is in an opening operation to the stop position, if a stop operation is not performed with the door switch 2H, the door 4 moves to the stop position and stops at the stop position. In the opening operation, the door 4 stops based on the stop operation of the door switch 2H. When a closing operation is selected with the door 4 in the open state, the door switch 2H closes the door 4. When the door 4 is in a closing operation to the closed position, if a stop operation is not performed with the door switch 2H, the door 4 moves to the closed position and stops at the closed position. In the closing operation, the door 4 stops based on the stop operation of the door switch 2H. The door switch 2H outputs the operation state to the disembarking support device 10.

The vehicle sensor 2D comprises a vehicle switch 2I for switching the travelable state of the vehicle 1. For example, if the vehicle 1 is an internal combustion engine vehicle, the vehicle switch 2I is a starter switch (ignition switch: IG switch) for starting or stopping the engine. If the vehicle 1 is an electric vehicle, the vehicle switch 2I is a switch for starting or stopping the power supply device.

When the vehicle switch 2I is operated to the on state, it enables travel of the vehicle 1. When the vehicle switch 2I is operated to the off state while the vehicle 1 is in the on state, it disables travel of the vehicle 1. The vehicle switch 2I outputs the operation state to the disembarking support device 10.

The vehicle sensor 2D comprises a seat occupancy sensor 2J for detecting the seat occupancy state of the passenger. The seat occupancy sensor 2J outputs, for example, a detection value of a seat occupancy state in case of the passenger is seated in a seat provided in the vehicle 1. The seat occupancy sensor 2J outputs a detection value of a seat non-occupancy state in case of the passenger is not seated. The seat occupancy sensor 2J outputs the operation state to the disembarking support device 10.

The vehicle sensor 2D comprises a buckle switch 2K for detecting the fastening state of the seat belt buckle. The buckle switch 2K detects a fastening state in which the seat belt buckle is fastened to a receiving part, or an unfastened state in which the seat belt buckle is released from the receiving part. The buckle switch 2K outputs the operation state to the disembarking support device 10.

The vehicle 1 comprises an output unit 3 which operates in conjunction with the disembarking support device 10. The output unit 3 is controlled by the disembarking support device 10 and outputs notification content related to disembarking support control. The output unit 3 comprises, for example, a speaker 3A for outputting notification content linked to the disembarking support device 10 by sound. The speaker 3A may be configured to output sound from an audio device, a radio device, or a navigation device. The notification content includes, for example, an issue warning for notifying the approach of a moving body outside the vehicle and a disembarking support control end notification.

The output unit 3 comprises a display unit 3B for outputting notification contents linked to the disembarking support device 10 by image display. The display unit 3B may be configured to output image display in association with an audio device, a radio device, a navigation device, or a meter device. The image display includes, for example, an issue warning for notifying the approach of a moving body outside the vehicle, or a disembarking support control end notification. The display unit 3B may be an indicator provided on a door mirror or a meter device. The indicator may be configured to display an issue warning for notifying the approach of a moving body outside the vehicle.

The display unit 3B may be constituted by, for example, a touch panel which accepts touch operations by the passenger. In this case, the display unit 3B may also be constituted by an input unit which accepts operations by the passenger. The display unit 3B may display an image displaying for accepting an operation to open or close the door 4, or may be configured for accepting an operation to open or close the door 4 by the passenger. When accepting an operation to open or close the door 4, the display unit 3B may display an image captured by the vehicle exterior camera 2A.

The disembarking support device 10 comprises a control unit 11 for executing disembarking support control for controlling the opening and closing of the door 4 and for protecting passengers, and a memory unit 12 for storing data. The control unit 11 is constituted by at least one hardware processor such as a CPU (Central Processing Unit). The control unit 11 may be configured such that one or more processors, such as a processor for controlling the opening of the door 4 and a processor for disembarking support control, work cooperatively. The control unit 11 may be configured as an integrated unit integrated into one processor.

The memory unit 12 is constituted by a non-transitory storage medium such as a hard disk drive (HDD), a solid-state disk (SSD), etc. The memory unit 12 stores computer programs and data necessary for disembarking support control.

The control unit 11 recognizes the start of opening of the door 4 based on the detection value of the vehicle sensor 2D. The control unit 11 changes the door lock 4C from a locked state to an unlocked state based on the unlocking operation of the door lock switch 2G by the passenger. The control unit 11 changes the latch drive unit 4B from a latched state to an unlatched state based on the opening operation of the door switch 2H by the passenger. For the opening operation of the door switch 2H, a predetermined operation by the passenger may be recognized or contact of the passenger with the door knob may be recognized.

After the control unit 11 puts the latch drive unit 4B into an unlatched state, the control unit 11 controls the door drive unit 4A to move the door 4 in the movement direction, thereby increasing the opening degree of the door 4. The control unit 11 may control the door drive unit 4A to automatically move the door 4 in the movement direction. The control unit 11 may be configured to control the door drive unit 4A to power assist the operation of the passenger in the movement direction of the door 4. When the door 4 reaches the stop position, the control unit 11 stops the door drive unit 4A, and the door 4 stops at the stop position.

When a stopping operation is performed while the door 4 is reaching the stopping position, the control unit 11 stops the door drive unit 4A to stop the door 4. When a closing operation is performed while the door 4 is stopped at the stopping position, the control unit 11 controls the door drive unit 4A to move the door 4 to the closed position. When the door 4 reaches the closed position, the control unit 11 controls the latch drive unit 4B to a latched state and closes the door 4. When opening or closing the door 4, the control unit 11 executes disembarking support control to protect the passenger. For example, in case of a moving body approaching the vehicle 1 is present and the door 4 is in an open state, the control unit 11 executes disembarking support control to protect the passenger by issuing an issue warning.

The control unit 11 executes control to put the door 4 into an open state, and also executes disembarking support control. The control unit 11 judges whether or not the opening of the door 4 has started in case of the vehicle 1 is stopped. When the control unit 11 acquires a detection value indicating an open state of the door sensor 2F, it judges that the opening of the door 4 has started, and starts disembarking support control.

When the control unit 11 acquires a detection value indicating the release state of the door lock switch 2G, it judges that opening of the door 4 has started and starts disembarking support control. When the control unit 11 acquires a detection value for starting the opening operation of the door switch 2H based on the operation of the passenger, it judges that the door 4 has started to open and starts disembarking support control. When the control unit 11 acquires a detection value for starting the opening operation of the door switch 2H, it judges that the door 4 has started to open and starts disembarking support control.

The control unit 11 starts disembarking support control based on the detection value of the vehicle sensor 2D in case of opening of the door 4 has started. The control unit 11 judges whether a moving body approaching the vehicle 1 is present or not based on the detection value for detecting the environment around the vehicle 1 in case of the passenger is disembarking.

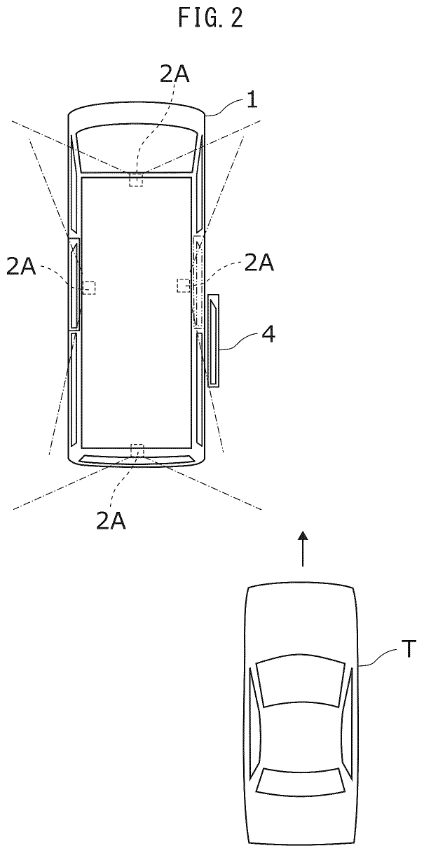

As shown in FIG. 2, the vehicle I executes the opening operation of the door 4. In this state, the vehicle exterior camera 2A captures the surrounding environment of the vehicle 1. A plurality of vehicle exterior cameras 2A may be provided so as to be able to capture the surrounding environment of the vehicle 1 within the capture range. The vehicle exterior camera 2A may be a panoramic camera capable of capturing the surrounding environment of the vehicle 1.

The control unit 11 analyzes the image data of the vehicle exterior camera 2A and judges whether a moving body T approaching the vehicle 1 is present. The moving body T includes, for example, other four-wheeled vehicles, motorcycles, bicycles, and other traffic participants. The control unit 11 is configured to recognize the environment around the vehicle 1 and to recognize a moving body approaching the vehicle 1 by executing machine learning such as deep learning using captured images as teacher data in advance.

The control unit 11 chronologically compares a plurality of sets of image data captured in the same direction, and extracts a moving body T from the image data. Among the moving bodies T, the control unit 11 extracts moving bodies T which have a potential to approach a passenger disembarking from door 4. The control unit 11 calculates the future position of the moving body T based on the relative distance between the position of the vehicle I and the moving body T, the relative movement direction of the moving body T, and the relative speed of the moving body T, and extracts moving bodies T which will approach vehicle 1. If the control unit 11 judges that a moving body approaching the vehicle 1 is present among the extracted moving bodies T, it executes disembarking support control.

The control unit 11 may recognize the approaching moving body T based on the detection values of the lidar device 2B and the radar device 2C. The control unit 11 may improve the recognition accuracy of the moving body T by a fusion process which combines the judgment result of the moving body T based on the image data and the judgment result of the moving body T based on the detection values of the lidar device 2B and the radar device 2C.

For example, in case of the control unit 11 is executing an automatic opening operation of the door 4, the control unit 11 controls the door drive unit 4A to stop the opening operation of the door 4. The control unit 11 stops the opening operation of the door 4 and outputs a predetermined notification content for issuing an issue warning to the passenger from the output unit 3. The control unit 11 outputs, for example, notification content by means of a voice issuing a warning regarding the approach of the moving body T or notification content by means of an alarm from the speaker 3A. The control unit 11 may increase the volume of the notification content or the alarm as the relative distance between the vehicle 1 and the moving body T decreases.

The control unit 11 outputs the notification content from the speaker 3A, and also outputs to the display unit 3B a display image for issuing a warning regarding the approach of the moving body T. The control unit 11 may output a display image for issuing a warning regarding the approach of the moving body T, such as displaying an image captured by the vehicle exterior camera 2A, on the display unit 3B and highlighting the approaching moving body T. The control unit 11 may output to the display unit 3B a blinking display of an image such as a color or a letter for issuing a warning regarding the approach of the moving body T. The control unit 11 may output to a display unit 3B (indicator) provided on the door mirror a display for issuing a warning regarding the approach of the moving body T.

When the control unit 11 recognizes a moving body approaching the vehicle 1 before judging that the opening of the door 4 has started, it may start disembarking support control, stop accepting the operation of the passenger to open the door 4, and prevent the opening operation of the door 4.

The control unit 11 resumes the opening operation of the door 4 in case of the danger of the moving body T to the passenger falls below a threshold. For example, in case of the recognized moving body T moves away from the vehicle 1 and the relative distance between the moving body T and the vehicle 1 becomes equal to or greater than a predetermined value, the control unit 11 resumes the opening operation of the door 4 and opens the door 4. When the danger of the moving body T to the passenger falls below a threshold, the control unit 11 may accept an opening operation of the door 4 by the passenger. After the passenger disembarks, in case of the control unit 11 detects a closing operation of the door 4, it closes the door 4 and sets the door 4 to a closed state.

The control unit 11 judges whether or not a cause for stopping the function of the vehicle 1 is satisfied based on a detection value that causes the function of the vehicle 1 to stop in case of the door 4 is closed. For example, the control unit 11 judges that a cause for stopping the vehicle 1 is satisfied in case of the vehicle switch 2I is turned off and a predetermined time (for example, three minutes) has elapsed. Even if the vehicle switch 2I is turned off and the predetermined time has not elapsed, the control unit 11 judges that a cause for stopping the vehicle 1 is satisfied in case of the control unit 11 detects a closing operation of the door lock switch 2G after the door 4 is closed.

The control unit 11 stops the disembarking support control in case of it judges that a cause for stopping the vehicle 1 has been established. After stopping the disembarking support control, the control unit 11 resumes the disembarking support control in case of the vehicle switch 2I is turned on or in case of the opening operation of the door lock switch 2G is detected.

When the vehicle disembarking support control is stopped, the control unit 11 executes output control for outputting notification contents for notifying the end of the disembarking support control to the output unit 3. For example, the control unit 11 outputs a sound for notifying the end of the disembarking support control from the speaker 3A. For example, the control unit 11 outputs a display image for notifying the end of the disembarking support control to the display unit 3B.

When the control unit 11 recognizes that a passenger is not present in the vehicle after the disembarking support control ends, the control unit 11 need not execute the output control. When the control unit 11 ends the disembarking support control, the control unit 11 judges whether or not a passenger is present in the vehicle 1 based on the detection value of the vehicle sensor 2D.

The control unit 11 judges whether or not a passenger is present in the vehicle 1 based on, for example, image data from the in-vehicle camera 2E. The control unit 11 is configured to be able to recognize a passenger who is present in the vehicle 1 based on, for example, machine learning such as deep learning using images captured in advance inside the vehicle 1 as teacher data. When the control unit 11 judges based on the image data that a passenger is present, it outputs notification contents to the output unit 3 to notify that disembarking support control will be ended. When the control unit 11 judges based on the image data that a passenger is not present, it does not execute output control to notify that disembarking support control will be ended.

The control unit 11 judges whether or not a passenger is present in the vehicle 1 based on, for example, a detection value of the seat occupancy sensor 2J. When the seat occupancy sensor 2J detects a passenger, the control unit 11 judges that the passenger is present in the vehicle 1, and outputs notification contents for notifying that disembarking support control will end to the output unit 3. The control unit 11 outputs notification contents for ending disembarking support control from the speaker 3A by means of sound. The control unit 11 outputs notification contents for ending disembarking support control from the display unit 3B by means of a display image. When the seat occupancy sensor 2J does not detect a passenger, the control unit 11 judges that a passenger is not present in the vehicle 1, and does not execute output control for notifying that disembarking support control will end.

The control unit 11 judges whether or not a passenger is present in the vehicle 1 based on, for example, the detection value of the buckle switch 2K. When the buckle switch 2K is in the on state, the control unit 11 judges that a passenger is present in the vehicle 1, and outputs notification contents for notifying that disembarking support control will be ended to the output unit 3. The control unit 11 outputs notification contents for ending disembarking support control from the speaker 3A by means of sound. The control unit 11 outputs notification contents for ending disembarking support control from the display unit 3B based on a display image. When the buckle switch 2K is in the off state, the control unit 11 judges that a passenger is not present in the vehicle 1, and does not execute output control for notifying that disembarking support control will be ended.

The control unit 11 judges whether or not a passenger is present in the vehicle 1 based on, for example, a detection value of the door lock switch 2G. The control unit 11 judges whether or not a passenger is present in the vehicle 1 based on a detection value of the door lock switch 2G operated from outside the vehicle 1 and a detection value of the door lock switch 2G operated from inside the vehicle 1. The control unit 11 acquires a detection value of the door lock switch 2G operated from outside the vehicle 1 based on, for example, a key operation such as a smart key. The control unit 11 acquires a detection value of the door lock switch 2G operated from inside the vehicle 1 based on, for example, the operation of the door lock switch 2G provided inside the vehicle.

When the door lock switch 2G is operated from inside the vehicle 1, the control unit 11 judges that a passenger is present inside the vehicle 1, and outputs notification contents to notify that disembarking support control will be ended to the output unit 3. The control unit 11 outputs the notification contents to end disembarking support control from the speaker 3A by means of sound. The control unit 11 outputs the notification contents to end disembarking support control from the display unit 3B by means of a display image. When the door lock switch 2G is operated from outside the vehicle 1 and the door locks 4C of all doors 4 are locked, the control unit 11 judges that a passenger is not present inside the vehicle 1, and does not execute output control to notify that disembarking support control will be ended.

The control unit 11 judges whether or not a passenger is present in the vehicle 1 based on at least one of the analysis result of the image data of the in-vehicle camera 2E, the detection value of the seat occupancy sensor 2J, the detection value of the buckle switch 2K, and the detection value of the door lock switch 2G operated from outside the vehicle 1. The control unit 11 may execute a fusion process based on a combination of two or more of the analysis result of the image data of the in-vehicle camera 2E, the detection value of the seat occupancy sensor 2J, the detection value of the buckle switch 2K, and the detection value of the door lock switch 2G operated from outside the vehicle 1, and judge whether or not a passenger is present in the vehicle 1. When the detection value of the door lock switch 2G operated from outside the vehicle 1 is detected, the control unit 11 may judge whether or not a passenger is present in the vehicle I regardless of the other detection values.

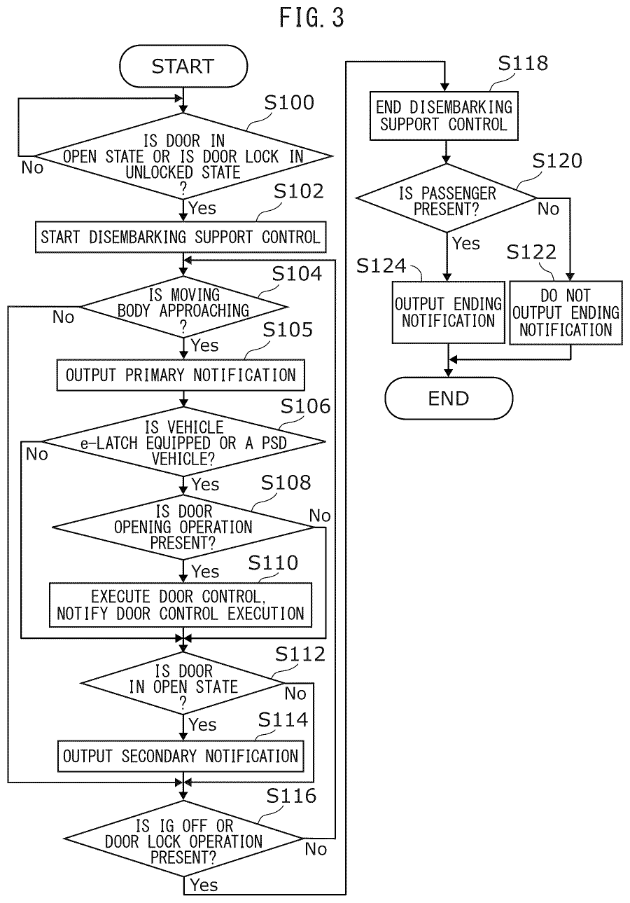

FIG. 3 shows the flow of processing of a disembarking support method executed by the disembarking support device 10. The disembarking support method is executed based on a computer program installed in a computer mounted on the disembarking support device 10. The computer program causes the disembarking support device 10 to execute each of the following processes.

The control unit 11 judges whether the door 4 is in an open state or not, or judges whether the door lock 4C of the door 4 is in an unlocked state or not (step S100). When the control unit 11 judges that the door 4 is in an open state or judges that the door lock 4C is in an unlocked state, the control unit 11 starts disembarking support control (step S102). The control unit 11 judges whether a moving body is approaching the vehicle 1 based on the detection values related to the moving body (step S104).

When the control unit 11 judges that a moving body is approaching, it outputs notification contents such as an indicator for issuing a warning of the approach of the moving body T to the display unit 3B provided on the door mirror as a primary notification (step S105). It judges whether the vehicle 1 is an e-latch equipped vehicle or whether the vehicle 1 is a PSD vehicle or not (step S106). When the control unit 11 judges negatively in step S106, the process advances to step S112.

When the judgment in step S106 is affirmative, the control unit 11 judges whether or not the opening operation of the door 4 is present (step S108). When the control unit 11 judges that the opening operation of the door 4 is present, control to suppress the opening operation of the door 4 is executed and notification contents informing the approach of the moving body and notification contents informing the execution of door control are output from the output unit 3 (step S110).

The notification contents include, for example, blinking an indicator of the display unit 3B provided in the door mirror, outputting a display image on the display unit 3B provided in a meter device, outputting an alarm sound or voice notification from the speaker 3A, etc. The alarm sound may be, for example, an intermittent buzzer sound which sounds a predetermined number of repetitions (for example, twice).

When the control unit 11 judges that the opening operation of the door 4 is not present, the process proceeds to step S116. The control unit 11 judges whether the door 4 is in an open state (step S112). If the door 4 is in an open state, the control unit 11 outputs notification contents informing the approach of the moving body as a secondary notification (step S114).

The secondary notification contents include, for example, blinking an indicator of the display unit 3B provided in the door mirror, outputting a display image notifying the approach of a moving body to the display unit 3B provided in a meter device, outputting an alarm sound or voice notification notifying the approach of a moving body from the speaker 3A, etc. The alarm sound may be, for example, a continuous or intermittent buzzer sound.

The control unit 11 judges whether a predetermined time (for example, 3 minutes) has elapsed after the vehicle switch 2I was turned off, or judges whether the door lock switch 2G has been operated to the locked state (step S116). When the control unit 11 judges negatively in step S116, the process returns to step S104. When the control unit 11 judges positively in step S116, the control unit 11 ends the disembarking support control (step S118).

The control unit 11 judges whether or not a passenger is present in the vehicle 1 based on the detection value regarding the presence of the passenger (step S120). When the control unit 11 judges that a passenger is not present in the vehicle 1, output control for notifying that disembarking support control will end is not executed (step S122). When the control unit 11 judges that a passenger is present in the vehicle 1, output control for notifying that disembarking support control will end is executed (step S124).

According to the disembarking support device 10 as described above, if a moving body is present outside the vehicle 1 in case of the passenger is disembarking, the opening operation of the door 4 can be restricted to protect the passenger. According to the disembarking support device 10, since the end of the disembarking support control is not notified if a passenger is not present inside the vehicle 1 in case of the disembarking support control ends, passengers who have disembarked outside the vehicle 1 can be less annoyed by notifications.

According to the disembarking support device 10, in case of disembarking support is ended, by detecting that the door lock switch 2G has been operated from outside the vehicle 1, output control for notifying that disembarking support control will end is not executed, thereby reducing the anxiety and annoyance felt by the passenger who operated the door lock switch 2G from outside the vehicle 1 due to the output control.

In the above-described embodiment, the computer program executed in each component of the disembarking support device 10 may be provided in a form recorded on a computer-readable portable non-transitory recording medium such as a semiconductor memory, a magnetic recording medium, or an optical recording medium. The computer program may be provided as a program product.

1. A disembarking support device comprising a processor for executing disembarking support control for protecting a passenger by issuing a warning in case of a moving body approaching a vehicle is present and a door is in an open state in case of the passenger is disembarking from the vehicle, the processor executing the following processing:
judging whether the passenger is present in the vehicle in case of ending the disembarking support control,
executing output control for outputting notification contents for notifying ending of the disembarking support control in case of it is judged that the passenger is present, and
not executing the output control in case of it is judged that the passenger is not present.

2. The disembarking support device according to claim 1, wherein the processor judges whether or not the passenger is present in the vehicle based on image data captured in the vehicle.

3. The disembarking support device according to claim 1, wherein the processor judges whether or not the passenger is present in the vehicle based on a detection value of a seat occupancy sensor for detecting a seat occupancy state of the passenger.

4. The disembarking support device according to claim 1, wherein the processor judges whether or not the passenger is present in the vehicle based on a detection value of a buckle switch for detecting a fastening state of a buckle of a seatbelt provided in the vehicle.

5. A non-transitory storage medium on which there is stored a computer program which is installed on a computer for executing disembarking support control for controlling an opening/closing operation of a door to protect a passenger in case of it is judged that a moving body approaching a vehicle is present based on a detection value detecting an environment around the vehicle in case of the passenger is disembarking, the non-transitory storage medium executing the following processing on the computer:
judging whether the passenger is present in the vehicle in case of ending the disembarking support control,
executing output control for outputting notification contents for notifying ending of the disembarking support control in case of it is judged that the passenger is present, and
not executing the output control in case of it is judged that the passenger is not present.
